(19) United States
(12) Patent Application Publication
(10) Pub. No.: US 2009/0164457 A1
(43) Pub. Date: Jun. 25, 2009

(54) Information collection, filtering and distribution method and system

(75) Inventors: Per Olav Aarnes, Stavanger (NO); Trond Kjetil Lindanger, Stavanger (NO)

Correspondence Address: LADAS & PARRY LLP, 26 WEST 61ST STREET, NEW YORK, NY, 10023, US

(73) Assignee: DK DIGITAL SYSTEMS AS

(21) Appl. No.: 12/004,091

(22) Filed: Dec. 19, 2007

(51) Int. Cl. G06F 17/30

(52) U.S. Cl. 707/5; 707/E17.017

(57) ABSTRACT

A method and a corresponding system for collecting, filtering and distribution of electronic information comprising the following steps: collecting information items from information channels of different types, filtering the information items according to filtering specifications, assigning the filtered information items to information queues and supplying the information queues to information consumers.

### TECHNICAL FIELD

The present invention relates to the field of information handling. More specifically, it relates to a method and a system for collecting electronically available information, and filtering and redistributing said information.

### BACKGROUND AND PRIOR ART

Since the advent of databases available through networks, users of these databases use some query tools from their workstations to interrogate these databases to access the information they want. With the advent of the internet, search engines and web feeds, not only the possibilities of searching for information have exploded, but also the number of users who make use of these possibilities. This again implies a huge amount (exponentially) of resources in terms of working time is used for this purpose. More and more information is distributed via electronic mail, resulting in an overflow that ends with important information getting lost in the big flow. Time pressure and information load increase, but human capacity stays more or less unchanged. Enormous resources are shed while manual search is being done in e-mail inboxes, bloggs, newspapers and feeds to find items that matter. Intervention is needed to sifter the information flow, avoiding loss of important information and ensure retrieval of relevant content.

State of the art comprise Google News which is a news portal web service that lets the users read and search for news in some defined news categories that Google has set up for each country, containing several thousand sources in total. Users can select which categories to show on a personalized web page, and also make their own categories, based on one of the existing, and with a persistent search, sifting the category content. The personalized page can be shared with other users as a total. Users can not specify which channels to read news from, they will get news from all sources included in the category or no news at all. Google News cannot be installed in-house, i.e. for fetching information from organization internal sources.

Yahoo Pipes is also a web solution and offers users the possibility to add their own feeds by URL, group them into groups of their own choice, and filter by one or more filters. The result can be piped into a new feed to be read from a separate feed reader. Yahoo Pipes can not be installed in-house.

Attensa offers a server for in-house installation, and hence feeds from internal channels can be included. An administrator adds feeds and set up access to them. They can be read through various Attensa readers, but users can not set up their own sources and there seems to be limited support for aggregation.

NewsGator is also all administrator operated. The administrator can search for feed sources on the internet, and choose which feeds should be available for the users. Feeds can be searched, ad-hoc or persistently. Allow access for both internal and external feeds. Offers access through web, portals, e-mail clients, desktops and mobile devices.

KnowNows Enterprise Syndication Server gathers information from various channels, including feeds, does some relevancy based organizing, comprising filtering and aggregation, and delivers the information to end users by RSS.

There is obviously a need to improve efficiency of access to relevant information from electronic sources. The present invention does improve this access and thus saves resources.

### SUMMARY

The present invention discloses a method and a system for collecting, filtering and distribution of electronic information. The method is characterized by the following steps: collecting information items from one or more information channels, filtering the information items according to a predetermined filtering specification, assigning the filtered items to an information queue, and supplying the information queue to information consumers.

The corresponding system comprises a collector module to fetch information items from one or more information channels, a filter to filter the information items according to a predetermined filtering specification, an information queue to assign said information items to, and means to supply said information queue to information consumers.

Further aspects of the present invention comprise a management module and corresponding method to be used by information managers to manage channel groups, information consumers, and information consumer groups; or by said information consumers to manage at least own (private) channel groups, which can be made available to be used by other information consumers or information consumer groups.

Another aspect of the present invention is that information consumers and/or information consumer groups can be externally defined users or user groups.

For further details and aspects of the invention, reference is made to the attached claim set.

### BRIEF DESCRIPTION OF THE DRAWINGS

Below the present invention will be described with reference to the attached drawings where

FIG. 1 shows an overview about the structure of the system;

FIG. 2 shows a flow chart describing the process of fetching new information items from information channels;

FIG. 3 shows a flow chart describing the process of adding information channels to the system.

### DETAILED DESCRIPTION OF PREFERRED EMBODIMENTS

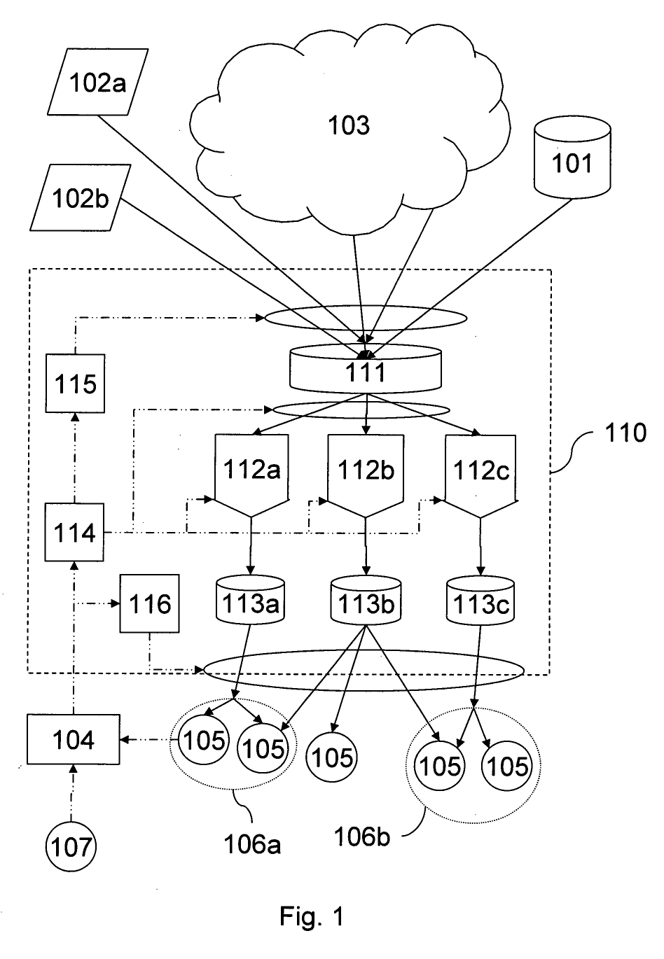

FIG. 1 shows the logical structure of the invention which typically is implemented as server software 110 and an administration client 104. The server software performs a sequence of steps comprising:

External information sources/channels, such as local databases 101 of—for instance—an organization, particular external sources such as individual, private supplies of news 102a, 102b and the Internet (RSS-feeds, blogs, email accounts, ftp sites . . . ) or other networks 103 are interrogated for information items. Which particular channels to interrogate, is indicated by a channel list 115 which in turn is generated from the contents of all channel groups 114 (see below). In this example in FIG. 1 the channel list defines 5 channels: a local database 101, two private information channels 102a, 102b, and two channels from the internet 103 (not separately numbered in FIG. 1).

The information items fetched from the information channels 101-103 according to the channel list 115 are preferably stored 111 before any further processing. The information items can be emails, blogs, RSS-elements and other data elements, provided sufficient tools are available to fetch the information items and to convert them into a suitable format. For internal databases 101, a solution is to integrate feeding modules into the database which interrogate the database at predetermined points in time and supply the information in a format suitable for the server 110. For emails, a tool can read incoming emails from an email account (the email account for instance being target for an email-newsletter) and forward the converted contents of the email to the server 110.

In a following step all the fetched information items are (fetched from storage if previously stored and) assigned to channel groups—3 groups in the example of FIG. 1, indicated by the postfixes a,b,c. The channel groups are defined by one data structure 114 pr channel group specifying which information channels 101-103 shall be included in the group, i.e. which of the (stored 111) information items shall be included. These items are then filtered 112a-c according to at least one filtering specification, the filtering specification also being part of the channel group data 114. The filtering specification can be a logical expression of any technically feasible complexity. A definition language for the filtering specification could be a SQL dialect or a structured search engine language as known to the person skilled in the field. A missing filtering specification is interpreted such that no filtering occurs at all, but all information items pass the filter step 112.

In a following step the information items having passed the filters 112a-112c are preferably stored 113a-c in some linked form.

Finally the ready-made information queues are fetched by, or otherwise transferred to, the information consumers 105. This can be done by representing the information items as an RSS-feed to be fetched by the consumer (“pull”), but they can also be transferred to the consumer by using some “push” technology, to a computer or mobile device, or any other means for distribution of information can be used.

The timing of all the steps of the method can be implemented in various ways. All the steps could be performed in sequence each time a consumer requests the latest information: fetching all available items from the source channels 101-103, filtering according the specification, assembling the filtered items into a queue and transferring the queue to the requesting consumer. A preferred embodiment of the invention however is interrogating the source channels at regular intervals for new items and storing the information items at the server 111. The next three steps according to this embodiment of the invention—channel group assignment and filtering—could be done at regular intervals too, if finished by storing (third step) the information queues. The ready-made queues do then wait for being fetched (“pull”) or are sent out (“push”) immediately. Other combinations of “pull” and “push” initiated operations can be employed and will be obvious for the skilled person.

For setting up the channel groups 114—and implicitly the channel list 115 —for the server 110, the administration or management module 104 (also known as “client”) is used. An administrator (=privileged user) 107 can in this way provide the server with specifications of channel groups:
which channels 101-103 to interrogate for information items,
which filtering specifications to filter 112 said information items with, and
which consumers 105 or groups of consumers 106 to receive the information items.

The information consumers 105 themselves may also be permitted to define one or more channel groups, for own use—but may also be allowed to make their channel groups available to other consumers or consumer groups by a technical sharing option.

The administrator is additionally allowed to set these combinations for single consumers 105 and consumer groups 106a, 106b. In the example structure in FIG. 1, the information queue 113a-c is assigned to the consumer group 106a and 106b respectively, i.e. the information items of the queue 113a and 113c are transferred to all consumers 105 in group 106a and 116b respectively, while information queue 113b is distributed to single consumers, not groups. The single consumers receiving information queue 113b.

In a preferred embodiment of the invention the administrator is allowed to define consumer groups.

Even if the structure above is described for a 2-level hierarchy (administrator-consumer) also a multi-level hierarchy is possible—including for instance group administrators (not shown).

Generally it is also possible to replace the consumer (=“user”) and group related modules and structures of the administration module 104 by modules making use of externally available user definitions and corresponding group definitions. This is advantageous in real-life where people already are assigned to a number of groups like company departments and the like, and it can be easier not to introduce new group structures but to reuse existing ones. This is in many cases a preferred embodiment of the present invention and easy to implement, since the distribution of the information sequences lies at the border of the server 110. Such externally available definitions are given by directory services and similar.

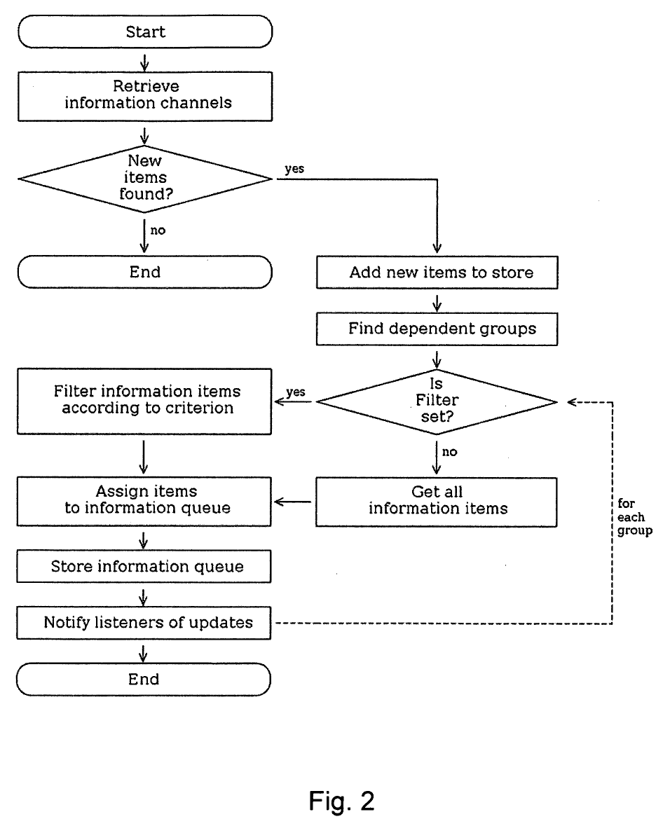

FIG. 2 shows a flow chart describing the procedure performed by the server 110 in a similar way as FIG. 1. The result of performing this process is an updated information queue. The embodiment described in FIG. 2 is based on RSS-feeds to be used as outgoing information structures.

The process starts by fetching all new information items from the channels defined by the channel list 115, where the channel list in turn is defined by all channel specifications in all the channel groups 114. If the channels do not deliver any new information items the process is terminated. If on the other hand there are any new items, the new items are stored 111 before processing continues with filtering and building of information queues 112 for all channel groups. For each channel group and each information item belonging to that channel group (according to the fact that the item came from a channel being specified in this channel group) it is checked if a filter is set and in case, the filtering condition is applied. If the information item matches the filtering specification—or there is no filtering specification set at all—the information item passes the filter and is attached to the information queue belonging to the channel group and stored 113 in case the queue is transferred to the information consumers (listeners) by some “pull”-type procedure. The information consumers being assigned to the current channel group can be notified. In case of a “push”-type procedure, the queues can be transferred to the assigned 116 consumers immediately without being stored. After having processed all information items and thus all channel groups, the process terminates.

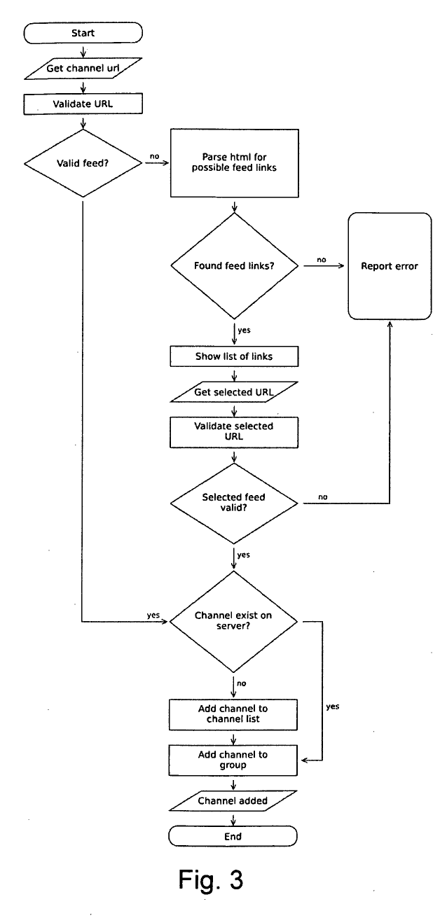

FIG. 3 illustrates an embodiment of a functional part of the client module 104 (FIG. 1). The procedure described here is used to assign a new information channel to a channel group 114 and correspondingly to the channel list 115. After having specified a channel-URL the URL is validated first.

If the URL is recognized as being usable directly as a feed of information items, most of the rest of the procedure is skipped and the URL is put into the channel list 115 unless it exist there already. Then the URL is also put into the desired channel group 114, where also the filter specification is stored, terminating the procedure successfully.

If the URL is recognized as NOT being usable directly for fetching information items, the document addressed by the URL is parsed for possible feed links. If no possible feed URLs are found, an error is indicated since the request for creating a new source channel could not be served. If however usable feed links are found they are presented to the user of the management (“client”) module 104 to select one of them. If the selected URL is validated to be usable as an information channel 101-103, it is handled as described above leading to successful termination of the procedure. In the other case—the selected link fails the validation—an error is reported.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1. Method for collecting, filtering and distribution of electronic information, characterized by the following steps:
a) collecting information items from at least one information channel,
c) filtering said information items according to a filtering specification, thereby providing filtered items,
d) assigning said filtered items to an information queue, and
f) supplying said information queue to at least one information consumer.

2. Method according to claim 1, characterized in that said information channels comprise:
local databases,
private information distribution channels,
Internet resources.

3. Method according to claim 1, characterized by a additional step b) between steps a) and c):
b) storing said collected information items.

4. Method according to claim 1, characterized by an additional step e) between steps d) and f):
e) storing said information queue.

5. Method according to claim 2, characterized in that said Internet resources comprise web feeds, blogs and email newsletters.

6. Method according to claim 2, characterized in that collecting said information from said databases comprises using feeding modules integrated into said databases.

7. Method according to claim 1, characterized in that said filtering specification uses a structured search engine syntax.

8. Method according to claim 1, characterized in that said information queues are RSS feeds.

9. Method according to claim 3, characterized in that said at least step f) is initiated by at least one of
request by said consumers (“pull”), and
availability of updated information queues (“push”).

10. Method according to claim 1, characterized in that said consumers can be assigned to at least one consumer group.

11. Method according to claim 1, characterized in that
specifications of at least one of said information channels and
said filtering specification
are combined to a channel group, wherein each channel group is associated with one information queue.

12. Method according to claim 11, characterized in that a missing filtering specification is handled as an “always TRUE”-filtering condition.

13. Method according to claim 11, characterized in that a management module is used by at least one of
an information manager to manage at least one of
(i) said channel groups,
(ii) information consumers, and
(iii) information consumer groups;
said information consumers to manage at least one of
(iv) own (private) channel groups.

14. Method according to claim 13, characterized in that said (iv) own (private) channel groups can be made available to be used by other at least one of information consumers and information consumer groups.

15. Method according to claim 13, characterized in that said at least one of (ii) information consumers, and (iii) information consumer groups are externally defined users and user groups.

16. System for collecting, filtering and distribution of electronic information, characterized by:
a) a collector module to fetch information items from at least one information channel,
c) a filter to filter said information items according to a filtering specification, thereby providing filtered information items,
d) an information queue structure to assign said filtered information items to, and
f) means to supply said information queue to at least one information consumer.

17. System according to claim 16, characterized in that said information channels comprise:
local databases,
private information distribution channels,
Internet resources.

18. System according to claim 16, characterized by storing means to store said collected information items.

19. System according to claim 16, characterized by storing means to store said information queue.

20. System according to claim 17, characterized in that said Internet resources comprise web feeds, blogs and email newsletters.

21. System according to claim 17, characterized by feeding modules integrated into said databases.

22. System according to claim 16, characterized by a structured search engine syntax to be used with said filtering specification.

23. System according to claim 16, characterized by said information queues being RSS feeds.

24. System according to claim 18, characterized by being arranged to initiate transfer of information queues to said consumers by at least one of
request by said consumers (“pull”), and
availability of updated information queues (“push”).

25. System according to claim 16, characterized by information consumers being assignable to at least one consumer group.

25. System according to claim 16, characterized by channel groups comprising
specifications of at least one of said information channels and
said filtering specification
wherein each channel group is associated with one information queue.

27. System according to claim 26, characterized in that a missing filtering specification is handled as an “always TRUE”-filtering condition.

28. System according to claim 26, characterized by a management module for use by at least one of
an information manager to manage at least one of
(i) said channel groups,
(ii) information consumers, and
(iii) information consumer groups;
said information consumers to manage at least one of
(iv) own (private) channel groups.

29. System according to claim 28, characterized by said (iv) own (private) channel groups being available to other at least one of information consumers and information consumer groups.

30. System according to claim 28, characterized by at least one of (ii) information consumers, and (iii) information consumer groups being externally defined users and user groups.
